(19) United States
(12) Patent Application Publication
(10) Pub. No.: US 2025/0147618 A1
(43) Pub. Date: May 8, 2025

(54) TOUCH DEVICE AND OPERATION METHOD THEREOF

(71) Applicant: Novatek Microelectronics Corp., Hsinchu (TW)

(72) Inventors: Chin-Tang Chang, Hsinchu City (TW); Yun-Hsiang Yeh, Hsinchu City (TW); Ta-Keng Weng, Taichung City (TW)

(73) Assignee: Novatek Microelectronics Corp., Hsinchu (TW)

(21) Appl. No.: 18/502,079

(22) Filed: Nov. 6, 2023

(51) Int. Cl. G06F 3/041

(52) U.S. Cl. CPC G06F 3/04166

(57) ABSTRACT

The touch device includes a processor and a driving circuit. The processor performs an active object detection through the driving circuit to detect a first position of an active stylus on a touch panel. The processor performs a passive object detection through the driving circuit to detect a second position of a passive object on the touch panel. The processor defines a first detection range including the first position. The processor defines a second detection range on the touch panel based on the first detection range, in which the first detection range is mutually exclusive from the second detection range. Then, the processor performs the active object detection in the first detection range through the driving circuit, and the processor disables or ignores the active object detection in the second detection range.

### BACKGROUND

### Technical Field

The disclosure relates to an electronic device, and in particular to a touch device and its operation method.

### Description of Related Art

Touch panels have been widely used in various electronic devices. Some touch panels can perform the passive object detection and active object detection in a time division multiplex manner. In the passive object detection, the touch device can detect the passive object through the touch panel, such as fingers or a passive stylus. In the active object detection, the touch device can detect the active object through the touch panel, such as an active stylus. Compared with a passive stylus, the active stylus has a smaller tip and better accuracy. In the operation process of the active object detection, the active stylus emits the downlink signal to the touch panel, and the touch device can determine the position of the active stylus on the touch panel after receiving the downlink signal through the touch panel.

The noise environment may affect the active object detection on the touch panel performed by the touch device. For example, in the operation process of the active object detection, the palm and the active stylus may be in contact with the touch panel at the same time, causing misjudgment of coordinates (since the position of the active stylus and the position of the palm are detected at the same time during the process of the active object detection). How to prevent the position of the active stylus from being affected by noise of the palm during the active object detection is one of many technical issues in this field.

### SUMMARY

The disclosure provides a touch device and an operation method thereof to prevent noise from affecting the detection of the position of an active stylus during an active object detection.

In an embodiment of the disclosure, the touch device includes a processor and a driving circuit. The driving circuit is coupled to the processor. The processor performs an active object detection on a touch panel through the driving circuit during a first period to detect a first position of an active stylus on the touch panel. The processor performs a passive object detection on the touch panel through the driving circuit during a second period different from the first period to detect a second position of a passive object on the touch panel. The processor defines a first detection range on the touch panel based on the first position of the active stylus, in which the first position is included in the first detection range. The processor defines a second detection range on the touch panel based on the first detection range, in which the first detection range is mutually exclusive from the second detection range. During a third period different from the first period and the second period, the processor performs the active object detection in the first detection range through the driving circuit, and the processor disables or ignores the active object detection in the second detection range.

In an embodiment of the disclosure, the operation method includes: performing an active object detection during a first period to detect a first position of an active stylus on a touch panel; perform a passive object detection during a second period different from the first period to detect a second position of a passive object on the touch panel; defining a first detection range on the touch panel based on the first position, in which the first position is included in the first detection range; defining a second detection range on the touch panel based on the first detection range, among them, in which the first detection range is mutually exclusive from the second detection range; and during a third period different from the first period and the second period, performing the active object detection in the first detection range, and disabling or ignoring the active object detection in the second detection range.

Based on the above, during the active object detection, the touch panel is at least divided into the first detection range and the second detection range mutually exclusive from each other, in which the first position of the active stylus on the touch panel is included in the first detection range. The processor can perform the active object detection in the first detection range through the driving circuit to learn the position of the active stylus on the touch panel. In addition, the processor can disable (or ignore) the active object detection in the second detection range to prevent noise from affecting the detection of the position of the active stylus during the active object detection.

In order to make the above-mentioned features and advantages of the disclosure more comprehensible, the embodiments are described in detail below with the accompanying drawings.

### BRIEF DESCRIPTION OF THE DRAWINGS

FIG. 1 is a circuit block schematic diagram of a touch device according to an embodiment of the disclosure.

FIG. 2 is a schematic flow chart of an operation method of the touch device according to an embodiment of the disclosure.

FIG. 3A and FIG. 3B are schematic scenario diagrams of a driving circuit in different object detections according to an embodiment of the disclosure.

FIG. 4A and FIG. 4B are schematic diagrams of a second detection range according to an embodiment of the disclosure.

FIG. 5A and FIG. 5B are schematic diagrams of a second detection range according to another embodiment of the disclosure.

### DESCRIPTION OF THE EMBODIMENTS

The word “coupled (or connected)” used throughout the specification of the disclosure (including the appended claims) may refer to any direct or indirect connection means. For example, if the text describes that the first device is coupled (or connected) to the second device, it should be interpreted to mean that the first device may be directly connected to the second device, or that the first device may be indirectly connected to the second device through other devices or some connection means. The terms “first” and “second” used throughout the specification of the disclosure (including the appended claims) are used to name elements or to distinguish different embodiments or ranges, and are not intended to limit the upper limit of the lower limit of the number of elements or to limit the order of elements. In addition, wherever possible, elements/components/steps with the same reference numerals are used in the drawings and embodiments to represent the same or similar parts. Elements/components/steps with the same reference numerals or the same terms in different embodiments may refer to each other for related descriptions.

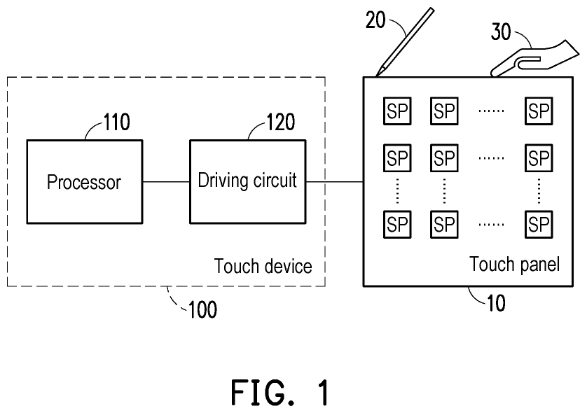

FIG. 1 is a circuit block schematic diagram of a touch device according to an embodiment of the disclosure. A touch panel 10 is disposed with a pad array (or an electrode array) having multiple sensor pads SP. Based on the operation of a touch device 100, the sensor pads SP can sense touch events on the touch panel 10, such as passive object touch events and/or active object touch events. This embodiment does not limit the implementation of the touch panel 10. For example, based on actual applications, the touch panel 10 may be a general (well-known) touch panel or other touch panels.

The touch device 100 can drive the touch panel 10 to perform the passive object detection and the active object detection in a time division multiplex manner. In the passive object detection, the touch device 100 can detect a passive object 30 through the touch panel 10, such as a palm or a passive stylus. In the operation process of the passive object detection, the touch device 100 may provide a driving signal (such as a pulse signal) to the touch panel 10, and then read the sensing result of the touch panel 10 to determine the position of the passive object 30 on the touch panel 10. In the active object detection, the touch device 100 may detect active objects through the touch panel 10, such as an active stylus 20. In the operation process of the active object detection, the active stylus 20 emits a downlink signal to the touch panel 10, and the touch device 100 can determine the position of the active stylus 20 on the touch panel 10 after receiving the downlink signal through the touch panel 10.

In the operation process of the active object detection, the active stylus 20 and the passive object 30 may be in contact with the touch panel 10 at the same time, thus causing misjudgment of the coordinates of the active stylus 20. The following embodiments will explain how the touch device 100 prevents noise of the passive object 30 from affecting the active object detection.

The touch device 100 shown in FIG. 1 includes a processor 110 and a driving circuit 120. According to different designs, in some embodiments, the implementation of the processor 110 may be a hardware circuit. In some other embodiments, the implementation of the processor 110 may be firmware, software (that is, program), or a combination of the above two. In still some embodiments, the implementation of the processor 110 may be a combination of hardware, firmware, and software.

In terms of hardware, the processor 110 may be implemented as a logic circuit on an integrated circuit. For example, related functions of the processor 110 may be implemented in one or more controllers, microcontrollers, microprocessors, application-specific integrated circuits (ASIC), digital signal processors (DSP), field programmable gate arrays (FPGA), central processing units (CPU), and/or various logic blocks, modules, and circuits in other processing units. Related functions of the processor 110 may utilize hardware description languages (such as Verilog HDL or VHDL) or other suitable programming languages to be implemented as hardware circuits, such as various logic blocks, modules, and circuits in integrated circuits.

In terms of software form and/or firmware form, the above-mentioned related functions of the processor 110 may be implemented as programming codes. For example, the processor 110 is implemented by using general programming languages (such as C, C++, or assembly languages) or other suitable programming languages. The programming codes may be recorded/stored in a “non-transitory machine-readable storage medium”. In some embodiments, the non-transitory machine-readable storage medium includes, for example, a semiconductor memory and/or a storage device. An electronic device (such as a CPU, a controller, a microcontroller, or a microprocessor) may read and execute the programming codes from the non-transitory machine-readable storage medium, thereby realizing the related functions of the processor 110.

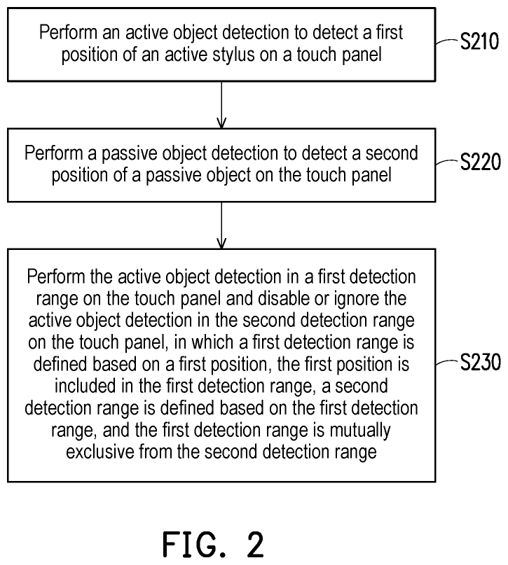

FIG. 2 is a schematic flow chart of an operation method of the touch device according to an embodiment of the disclosure. Referring to FIG. 1 and FIG. 2, the driving circuit 120 is coupled to the processor 110. In Step S210, the processor 110 can perform an active object detection on the touch panel 10 through the driving circuit 120 during a first period to detect the position (a first position) of the active stylus 20 on the touch panel 10. After Step S210 (for example, before Step S220, or before Step S230), the processor 110 can define a first detection range on the touch panel 10 based on the position of the active stylus 20 (the position of the active stylus 20 is included in the first detection range), and define a second detection range on the touch panel 10 based on the first detection range. The first detection range is mutually exclusive from the second detection range.

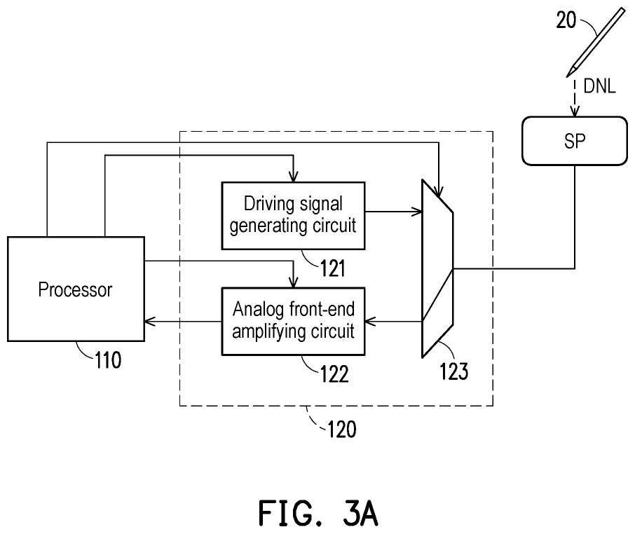

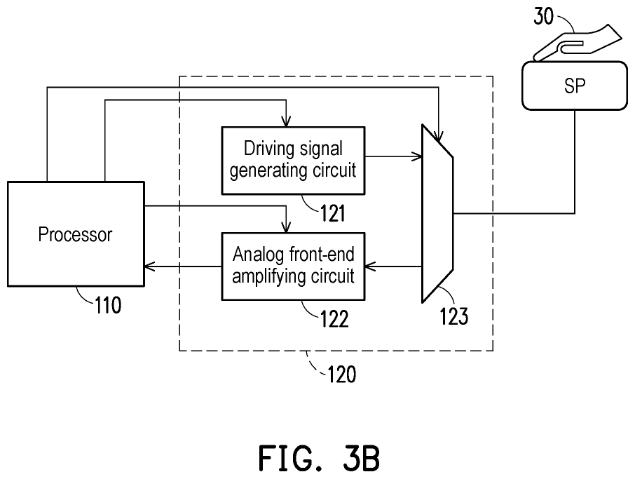

FIG. 3A and FIG. 3B are schematic scenario diagrams of a driving circuit in different object detections according to an embodiment of the disclosure. The driving circuit 120 shown in FIG. 3A and FIG. 3B may be used as one of many implementation examples of the driving circuit 120 shown in FIG. 1. In the embodiment shown in FIG. 3A and FIG. 3B, the driving circuit 120 includes a driving signal generating circuit 121, an analog front-end (AFE) amplifying circuit 122, and a multiplex circuit 123. The driving signal generating circuit 121, the analog front-end amplifying circuit 122, and the multiplex circuit 123 are controlled by the processor 110. The first selection end of the multiplex circuit 123 is coupled to the output end of the driving signal generating circuit 121. The second selection end of the multiplex circuit 123 is coupled to the input end of the analog front-end amplifying circuit 122. The common end of the multiplex circuit 123 is coupled to the sensor pad SP of the touch panel 10.

FIG. 3A is a schematic scenario diagram of the driving circuit 120 in an active object detection. In the active object detection, the multiplex circuit 123 selectively couples the sensor pad SP of the touch panel 10 to the input end of the analog front-end amplifying circuit 122. In the operation process of the active object detection, the active stylus 20 emits a downlink signal DNL to the touch panel 10, and the analog front-end amplifying circuit 122 may receive the downlink signal DNL through the multiplex circuit 123 and the sensor pad SP. The analog front-end amplifying circuit 122 may provide the amplified signal corresponding to the downlink signal DNL to the processor 110. After the processor 110 receives the downlink signal, the processor 110 can determine the position of the active stylus 20 on the touch panel 10.

Please refer to FIG. 1 and FIG. 2. In Step S220, the processor 110 can perform a passive object detection on the touch panel 10 through the driving circuit 120 during a second period to detect the position (a second position) of the passive object 30 on the touch panel 10. For example, the driving circuit 120 can perform the passive object detection on all sensing regions of the touch panel 10.

FIG. 3B is a schematic scenario diagram of the driving circuit 120 in a passive object detection. In a first time phase of the passive object detection, the multiplex circuit 123 selectively transmits a driving signal (e.g., a pulse signal) output by the driving signal generating circuit 121 to the sensor pad SP of the touch panel 10. In a second time phase of the passive object detection, the multiplex circuit 123 selectively couples the sensor pad SP of the touch panel 10 to the input end of the analog front-end amplifying circuit 122. Therefore, in the operation process of the passive object detection, the driving circuit 120 may provide the driving signal to the sensor pad SP, and then read the sensing result of the sensor pad SP. The analog front-end amplifying circuit 122 may provide the amplified signal corresponding to the sensing result for the processor 110. After the processor 110 receives sensing results of different sensor pads SP, the processor 110 can then determine the position of the passive object 30 on the touch panel 10.

Please refer to FIG. 1 and FIG. 2. In Step S230, during a third period, the processor 110 can perform the active object detection in the first detection range through the driving circuit 120, and the processor 110 can disable (or ignore) the active object detection in the second detection range. The first detection range is defined based on the position (the first position) of the active stylus 20, and the position of the active stylus 20 is included in the first detection range. The size and geometric shape of the first detection range may be determined according to different applications. The second detection range is defined based on the first detection range, in which the first detection range is mutually exclusive from the second detection range. The definition of the second detection range may vary according to different applications. The different embodiments of the second detection range will be described below.

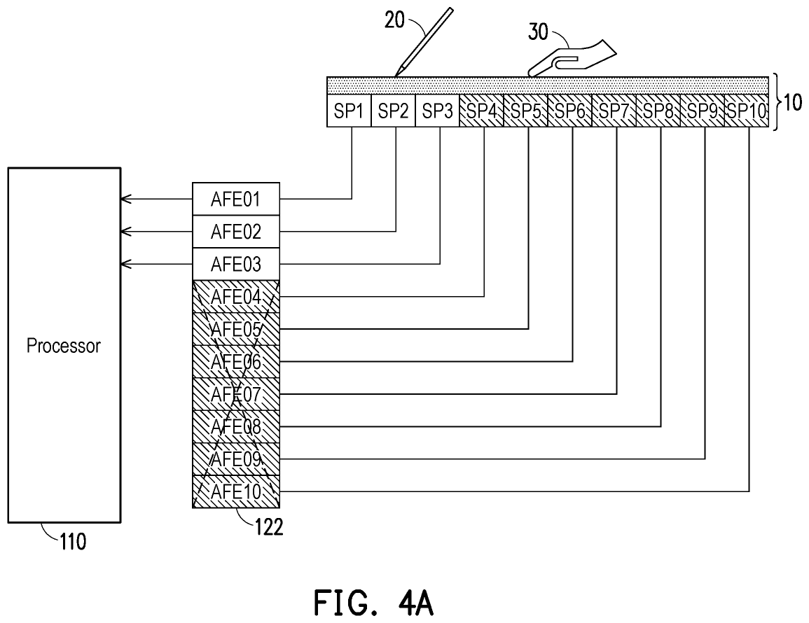

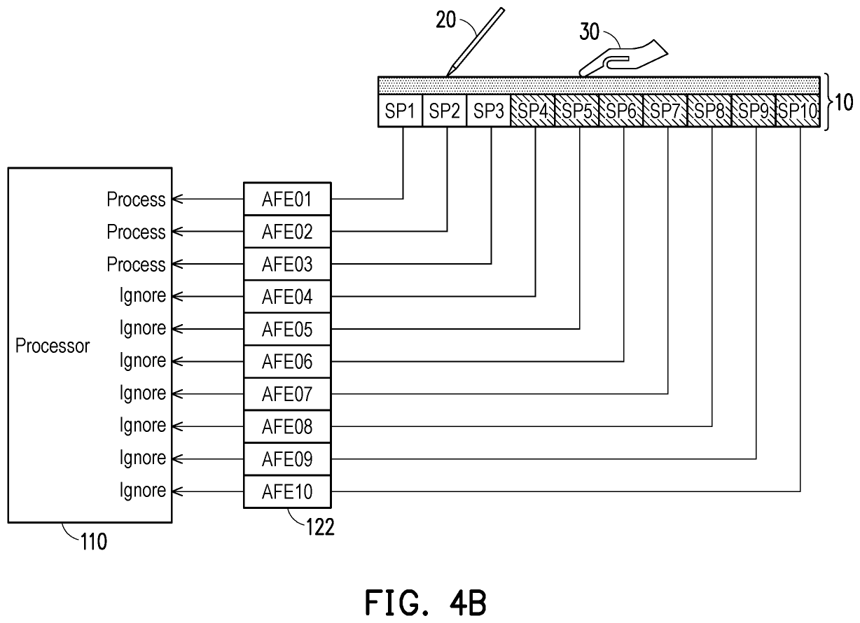

FIG. 4A and FIG. 4B are schematic diagrams of a second detection range according to an embodiment of the disclosure. For the touch panel 10, the active stylus 20, the passive object 30, and the processor 110 shown in FIG. 4A and FIG. 4B, reference may be made to the related description of the touch panel 10, the active stylus 20, the passive object 30, and the processor 110 shown in FIG. 1, FIG. 3A, and FIG. 3B, and for the analog front-end amplifying circuit 122 shown in FIG. 4A and FIG. 4B, reference may be made to the related description of the analog front-end amplifying circuit 122 shown in FIG. 3A and FIG. 3B. In the embodiment shown in FIG. 4A and FIG. 4B, the touch panel 10 includes sensor pads SP1, SP2, SP3, SP4, SP5, SP6, SP7, SP8, SP9, and SP10, and the analog front-end amplifying circuit 122 includes analog front-end amplifiers AFE01, AFE02, AFE03, AFE04, AFE05, AFE06, AFE07, AFE08, AFE09, and AFE10. For the sensor pads SP1 to SP10 shown in FIG. 4A and FIG. 4B, reference may be made to the related description of the sensor pad SP shown in FIG. 1, FIG. 3A, and FIG. 3B.

In the embodiment shown in FIG. 4A and FIG. 4B, the processor 110 can perform the active object detection on the touch panel 10 through the analog front-end amplifying circuit 122 during the first period to detect the position (the first position) of the active stylus 20 on the touch panel 10. Then, the processor 110 can define the first detection range on the touch panel 10 based on the position of the active stylus 20. Based on the position of the active stylus 20, as an example, it is assumed that the processor 110 defines the sensor pads SP1, SP2, and SP3 as the first detection range. In the embodiment shown in FIG. 4A and FIG. 4B, the processor 110 may define other ranges on the touch panel 10 except the first detection range as “second detection range”. As an example, it is assumed that other sensor pads SP4 to SP10 of the touch panel 10 are defined as the second detection range. Therefore, the analog front-end amplifiers AFE01 to AFE03 correspond to the “first detection range”, and the analog front-end amplifiers AFE04 to AFE10 correspond to the “second detection range”.

In the embodiment shown in FIG. 4A, the processor 110 can enable the analog front-end amplifiers AFE01 to AFE03 corresponding to the “first detection range” in the analog front-end amplifying circuit 122 to perform the active object detection on the sensor pads SP1 to SP3 (the first detection range). The processor 110 can disable the analog front-end amplifiers AFE04 to AFE10 corresponding to the “second detection range” in the analog front-end amplifying circuit 122 to disable the active object detection in the sensor pads SP4 to SP10 (the second detection range). In the subsequent operation of the passive object detection, the processor 110 can enable all analog front-end amplifiers AFE01 to AFE10 to perform the passive object detection on all sensing regions of the touch panel 10.

In the embodiment shown in FIG. 4B, the processor 110 can enable all analog front-end amplifiers AFE01 to AFE10 to perform the active object detection on all sensing regions of the touch panel 10. The processor 110 can receive and process the output of the analog front-end amplifiers AFE01 to AFE03 corresponding to the “first detection range” in the analog front-end amplifiers AFE01 to AFE10 to perform the active object detection in the sensor pads SP1 to SP3 (the first detection range). The processor 110 can ignore the output of the analog front-end amplifiers AFE04 to AFE10 corresponding to the “second detection range” in the analog front-end amplifiers AFE01 to AFE10 to ignore the active object detection in the sensor pads SP4 to SP10 (the second detection range). In the subsequent operation of the passive object detection, the processor 110 can receive and process the output of all analog front-end amplifiers AFE01 to AFE10 to perform the passive object detection on all sensing regions of the touch panel 10.

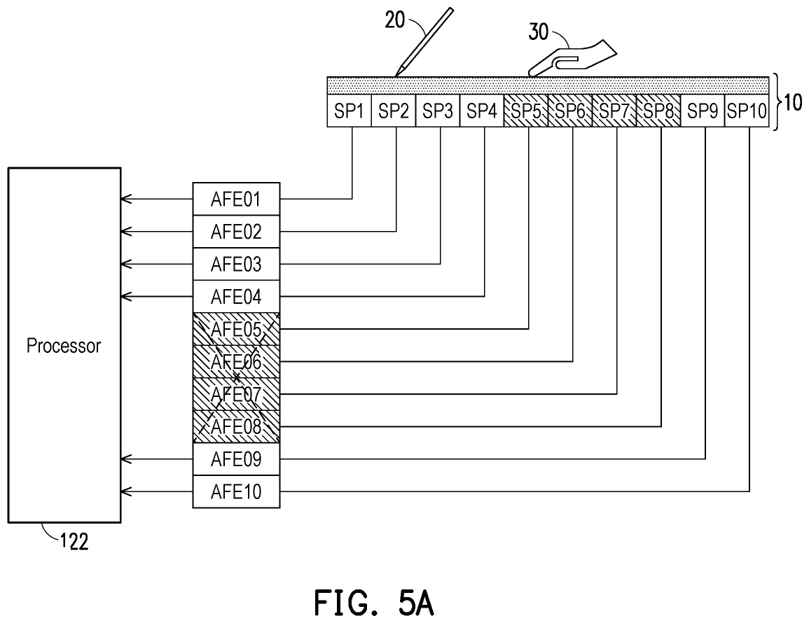

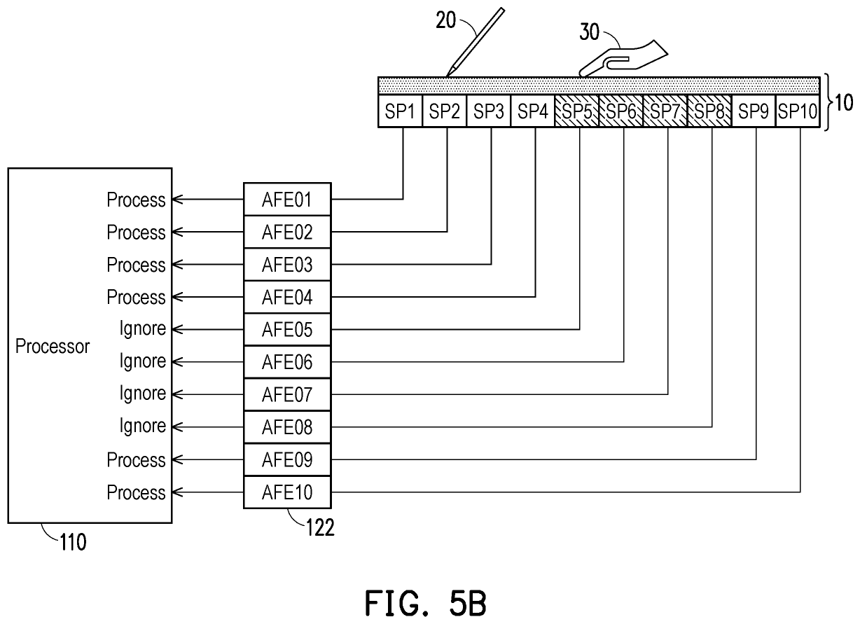

FIG. 5A and FIG. 5B are schematic diagrams of a second detection range according to another embodiment of the disclosure. For the touch panel 10, the active stylus 20, the passive object 30, and the processor 110 shown in FIG. 5A and FIG. 5B, reference may be made to the related description of the touch panel 10, the active stylus 20, the passive object 30, and the processor 110 shown in FIG. 1, FIG. 3A, and FIG. 3B, for the analog front-end amplifying circuit 122 shown in FIG. 5A and FIG. 5B, reference may be made to the related description of the analog front-end amplifying circuit 122 shown in FIG. 3A and FIG. 3B. In the embodiment shown in FIG. 5A and FIG. 5B, the touch panel 10 includes sensor pads SP1, SP2, SP3, SP4, SP5, SP6, SP7. SP8, SP9, and SP10, and the analog front-end amplifying circuit 122 includes analog front-end amplifiers AFE01, AFE02, AFE03, AFE04, AFE05, AFE06, AFE07, AFE08, AFE09, and AFE10. For the sensor pads SP1 to SP10 shown in FIG. 5A and FIG. 5B, reference may be made to the related description of the sensor pad SP shown in FIG. 1, FIG. 3A, and FIG. 3B.

In the embodiment shown in FIG. 5A and FIG. 5B, the processor 110 can perform the active object detection on the touch panel 10 through the analog front-end amplifying circuit 122 during the first period to detect the position (the first position) of the active stylus 20 on the touch panel 10. Then, the processor 110 can define the first detection range of the touch panel 10 based on the position of the active stylus 20. The processor 110 may define “second detection range” based on the first detection range of the active stylus 20 and the second position of the passive object 30. The position (the second position) of the passive object 30 is included in the second detection range, and the position of the active stylus 20 is located outside the second detection range. The processor 110 can perform the active object detection in other ranges on the touch panel 10 except “first detection range” and “second detection range” during the third period.

Based on the position of the active stylus 20 and the position of the passive object 30, as an example, it is assumed that the processor 110 defines the sensor pads SP1 to SP3 shown in FIG. 5A and FIG. 5B as the first detection range, and the sensor pads SP5 to SP8 shown in FIG. 5A and FIG. 5B as the second detection range. Therefore, the analog front-end amplifiers AFE01 to AFE03 correspond to the “first detection range”, the analog front-end amplifiers AFE05 to AFE08 correspond to the “second detection range”, and the analog front-end amplifiers AFE04, AFE09, and AFE10 correspond to “other ranges except the first detection range and the second detection range”.

In the embodiment shown in FIG. 5A, the processor 110 can enable the analog front-end amplifiers AFE01 to AFE04, AFE09 and AFE10 corresponding to the “first detection range” and “other ranges” in the analog front-end amplifying circuit 122 to perform the active object detection on the sensor pads SP1 to SP3 (the first detection range) and the sensor pads SP4, SP9, and SP10 (other ranges). The processor 110 can disable the analog front-end amplifiers AFE05 to AFE08 corresponding to the “second detection range” in the front-end amplifying circuit 122 to disable the active object detection in the sensor pads SP5 to SP8 (the second detection range). In the subsequent operation of the passive object detection, the processor 110 can enable all analog front-end amplifiers AFE01 to AFE10 to perform the passive object detection on all sensing regions of the touch panel 10.

In the embodiment shown in FIG. 5B, the processor 110 can enable all analog front-end amplifiers AFE01 to AFE10 to perform the active object detection on all sensing regions of the touch panel 10. The processor 110 can receive and process the output of the analog front-end amplifiers AFE01 to AFE03 corresponding to the “first detection range” and the output of the analog front-end amplifiers AFE04, AFE09, and AFE10 corresponding to the “other ranges” to perform the active object detection on the sensor pads SP1 to SP3 (the first detection range) and the sensor pads SP4, SP9, and SP10 (other ranges). The processor 110 can ignore the output of the analog front-end amplifiers AFE05 to AFE08 corresponding to the “second detection range” to ignore the active object detection in the sensor pads SP5 to SP8 (the second detection range). In the subsequent operation of the passive object detection, the processor 110 can receive and process the output of all analog front-end amplifiers AFE01 to AFE10 to perform the passive object detection on all sensing regions of the touch panel 10.

In summary, during the active object detection, the touch panel 10 is at least divided into the first detection range and the second detection range mutually exclusive from each other, in which the first position of the active stylus 20 on the touch panel 10 is included in the first detection range. The processor 110 can perform the active object detection in the first detection range through the driving circuit 120 to learn the position of the active stylus 20 on the touch panel 10. In addition, the processor 110 can disable (or ignore) the active object detection in the second detection range to prevent noise from affecting the detection of the position of the active stylus during the active object detection.

Although the disclosure has been disclosed above in the embodiments, the embodiments are not intended to limit the disclosure. Persons with ordinary knowledge in the technical field can make some modifications and modifications without departing from the spirit and scope of the disclosure. Therefore, the protection scope of the disclosure shall be determined by the appended claims.

What is claimed is:

1. A touch device, comprising:
a processor; and
a driving circuit coupled to the processor, wherein
the processor performs an active object detection on a touch panel through the driving circuit during a first period to detect a first position of an active stylus on the touch panel;
the processor performs a passive object detection on the touch panel through the driving circuit during a second period different from the first period to detect a second position of a passive object on the touch panel;
the processor defines a first detection range on the touch panel based on the first position of the active stylus, wherein the first position is comprised in the first detection range;
the processor defines a second detection range on the touch panel based on the first detection range, wherein the first detection range is mutually exclusive from the second detection range; and
during a third period different from the first period and the second period, the processor performs the active object detection in the first detection range through the driving circuit, and the processor disables or ignores the active object detection in the second detection range.

2. The touch device as claimed in claim 1, wherein the driving circuit comprises:
a driving signal generating circuit controlled by the processor;
an analog front-end amplifying circuit controlled by the processor; and
a multiplex circuit controlled by the processor, wherein a first selection end of the multiplex circuit is coupled to an output end of the driving signal generating circuit, a second selection end of the multiplex circuit is coupled to an input end of the analog front-end amplifying circuit, and a common end of the multiplex circuit is coupled to a sensor pad of the touch panel.

3. The touch device as claimed in claim 2, wherein,
in a first time phase of the passive object detection, the multiplex circuit selectively transmits a driving signal output by the driving signal generating circuit to the sensor pad of the touch panel;
in a second time phase of the passive object detection, the multiplex circuit selectively couples the sensor pad of the touch panel to the input end of the analog front-end amplifying circuit; and
in the active object detection, the multiplex circuit selectively couples the sensor pad of the touch panel to the input end of the analog front-end amplifying circuit.

4. The touch device as claimed in claim 1, wherein the processor defines other ranges on the touch panel except the first detection range as the second detection range.

5. The touch device as claimed in claim 1, wherein the processor defines the second detection range based on the first detection range of the active stylus and the second position of the passive object, the second position is comprised in the second detection range, and the first position of the active stylus is located outside the second detection range.

6. The touch device as claimed in claim 5, wherein the processor performs the active object detection in other ranges on the touch panel except the first detection range and the second detection range during the third period.

7. The touch device as claimed in claim 1, wherein
the driving circuit comprises a plurality of analog front-end amplifiers;
the processor disables at least one analog front-end amplifier corresponding to the second detection range among the analog front-end amplifiers to disable the active object detection in the second detection range; and
the processor enables at least one analog front-end amplifier corresponding to the first detection range among the analog front-end amplifiers to perform the active object detection in the first detection range.

8. The touch device as claimed in claim 1, wherein
the driving circuit comprises a plurality of analog front-end amplifiers;
the processor ignores an output of at least one analog front-end amplifier corresponding to the second detection range among the analog front-end amplifiers to ignore the active object detection in the second detection range; and
the processor receives and processes an output of at least one analog front-end amplifier corresponding to the first detection range among the analog front-end amplifiers to perform the active object detection in the first detection range.

9. An operation method of a touch device, comprising:
performing an active object detection during a first period to detect a first position of an active stylus on a touch panel;
performing a passive object detection during a second period different from the first period to detect a second position of a passive object on the touch panel;
defining a first detection range on the touch panel based on the first position, wherein the first position is comprised in the first detection range;
defining a second detection range on the touch panel based on the first detection range, wherein the first detection range is mutually exclusive from the second detection range; and
performing the active object detection in the first detection range and disabling or ignoring the active object detection in the second detection range during a third period different from the first period and the second period.

10. The operation method as claimed in claim 9, further comprising:
defining other ranges on the touch panel except the first detection range as the second detection range.

11. The operation method as claimed in claim 9, further comprising:
defining the second detection range based on the first detection range of the active stylus and the second position of the passive object, wherein the second position is comprised in the second detection range, and the first position of the active stylus is located outside the second detection range.

12. The operation method as claimed in claim 11, further comprising:
performing the active object detection in other ranges on the touch panel except the first detection range and the second detection range during the third period.

13. The operation method as claimed in claim 9, further comprising:
disabling at least one analog front-end amplifier corresponding to the second detection range among a plurality of analog front-end amplifiers to disable the active object detection in the second detection range; and
enabling at least one analog front-end amplifier corresponding to the first detection range among the analog front-end amplifiers to perform the active object detection in the first detection range.

14. The operation method as claimed in claim 9, further comprising:
ignoring an output of at least one analog front-end amplifier corresponding to the second detection range among a plurality of analog front-end amplifiers to ignore the active object detection in the second detection range; and
processing an output of at least one analog front-end amplifier corresponding to the first detection range among the analog front-end amplifiers to perform the active object detection in the first detection range.
